(19) United States
(12) Patent Application Publication
(10) Pub. No.: US 2012/0123790 A1
(43) Pub. Date: May 17, 2012

(54) MEDICAL PROFESSIONAL APPOINTMENT SCHEDULING AND PAYMENT SYSTEM AND METHOD

(76) Inventor: Erik Lamont Kenyon, Whiteville, NC (US)

(21) Appl. No.: 12/946,978

(22) Filed: Nov. 16, 2010

(51) Int. Cl. G06Q 10/00; G06Q 50/00

(52) U.S. Cl. 705/2

(57) ABSTRACT

The present invention relates to a method of scheduling and paying for visits with a medical professional. Specifically the present invention relates to a web based appointment service that relies on prepayment to schedule appointments from available doctors.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method of scheduling and paying for visits with a medical professional. Specifically the present invention relates to a web based appointment service that relies on prepayment to schedule appointments from available doctors.

2. Description of Related Art

Medical professional service providers, such as physician, dentist, veterinarian, optometrist, chiropractor, and the like, are all in the middle of a huge provider shortage. This is due to a number of factors, including an aging population, a growing population, declining numbers of professionals, as well as more restrictive healthcare reimbursement plans where professionals in increasing numbers are choosing not to participate. In addition, where insurance is provided, demand may make access to the professional weeks if not months away.

The whole issue of appointments is extremely important for the medical professional. The increase in patient population combined with decrease in numbers of medical professionals in the US and other factors, means that getting an immediate appointment with a medical professional is increasingly difficult. In addition, since over 90% of the public have some form of third medical reimbursement insurance, the payment of the doctor has gotten more difficult and frequently not only the professional doesn't get paid but also has spent increasing large amounts of time working on reimbursements, which in of itself, adds to the cost of providing medical services to a patient.

Online and other digital type systems have lowered the need for as many scheduling professionals leaving the assistants and clerical help free to do other tasks but that still has not relieved the pressure on the medical treatment system. This has become an increasing problem for patients who under certain circumstances where their regular primary care physician is busy, end up searching for other professionals which may or may not have the time to see the patient in a sooner time.

### BRIEF SUMMARY OF THE INVENTION

The present invention allows the patient to circumvent the shortage of professionals and uncertain appointment calendars. In addition, it solves the problem of payment of the professional and the utilization of third party payment systems. In exchange for prepayment in the form of cash, credit card, or the like, a plurality of physicians can make a number of additional appointments available in their calendar in the form of a guarantee to see the patient within a selected period of time. This allows patients a means of getting a quick appointment or at a specific time, and the professional is compensated for the extra work by not having to deal with the current reimbursement system.

Accordingly in one embodiment of the present invention there is a method for an individual to schedule an appointment with a healthcare professional comprising:
a) registering a plurality of healthcare professionals on an appointment scheduling system on an internet accessible server;
b) generating one or more time periods that an appointment is available for each of the plurality of healthcare professionals on the system;
c) registering the individual on the system;
d) allowing the patient to search the system and select a healthcare professional and an associated appointment time period;
e) requiring prepayment by the individual for the selected appointment time period; and
f) confirmation of date and time of an appointment of the selected healthcare professional and the individual once the appointment is prepaid.

In yet another embodiment there is an appointment scheduling system for registering an appointment for an individual with a healthcare professional comprising:
an appointment scheduling system on an internet accessible server wherein the system can perform the operations of:
   a) registering a plurality of healthcare professionals;
   b) generating one or more time periods that an appointment is available for each of the plurality of healthcare professionals;
   c) registering the individual;
   d) allowing the patient to search the system on the internet and select a healthcare professional and an associated appointment time period; and
   e) requiring prepayment by the individual for the selected appointment time period;
   and an appointment delivery system for delivering a confirmation of the precise date and time of an appointment of the selected healthcare professional and the appointment is given to the individual once the appointment is prepaid.

### BRIEF DESCRIPTION OF THE DRAWINGS

FIG. 1 is a relationship diagram of the patient and healthcare professional.

FIG. 2 is a block diagram of the search process of the present invention.

FIG. 3 is a block diagram of the prepayment process of the present invention.

FIGS. 4a and 4b are block diagrams of the internet process for the healthcare professional and the patient using the system on the internet.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “individual” refers to a person or animal who is seeking treatment by a healthcare professional. In particular, the present invention relates to an individual who needs the medical professional service and cannot get a timely appointment using the standard appointment scheduling method of the individual's regular healthcare professional. For example, where a patient cannot get to see their urologist for an extended time such as 3 months, the individual would be searching for a sooner appointment either with the regular healthcare professional or another healthcare professional found and paid for utilizing the system of the present invention.

As used herein a “healthcare professional” refers to any professional that can provide healthcare to a patient individual that needs an appointment that is difficult to obtain. Examples of healthcare professionals include, Physicians, Dentists, Veterinarians, Optometrists, Chiropractors, specialists within these categories, and the like. The healthcare professional can be the patient's regular healthcare professional or one that is not the regular healthcare professional.

As used herein, the phrase “scheduling an appointment” refers to getting a healthcare professional meeting at a given date and time using the method of the present invention. Rather than the normal process of calling and selecting an available time in the future based on the next available dates and times, appointments herein refer to selecting a range of time (in days for example) and then once selected and paid for, the professional will work with the patient to assign a specific time and day to arrive for the appointment.

As used herein an “appointment scheduling system” refers to an online system, such as on the internet, that allows the individual patient to see the available Healthcare Professionals which have appointments available and the ability to search for the professional based on a selected criteria. Criteria can include, but is not limited to, locations (such as by zip code), specialty, subspecialty (e.g. allergist within the physician category), and the like. It can also be based on the particular time frame that is available for the appointment.

As used herein the term “internet” refers to the internet world wide web, any replacements to the internet, or any other digital system of interconnected digital processing (computers, servers, etc.) devices for the purposes of connecting and exchanging information. It can also include a private intranet or the like.

As used herein an “internet accessible server” refers to a digital processor (computer or the like) which is connected to the internet and allows access by physicians and individuals to the server and the appointment system of the present invention on the server. In one embodiment it is a single computer or server while in other embodiments it can be multiple processing devices either connected directly or connected through the internet or other means (intranet, e.g.).

The “appointment scheduling system” of the present invention is specific to the method and means of scheduling an appointment with a healthcare professional of the present invention. The system allows a plurality of healthcare professionals to sell appointment times during a specific period of time in exchange for prepayment (cash, credit card, or the like) for the appointment, thus avoiding the cost and uncertainty of dealing with a third party provider. The system is a software based system in resident memory on the accessible server or other processing device. It is a form of cloud computing thus requiring little or no software on either the healthcare professional or individual's personal computer that they use to access the internet. It comprises a means for healthcare professionals to sign up, log in place their profile information on, and the like. It then also allows the healthcare professional to pick specific dates and times or date ranges (e.g. the third week of October, or a will be seen by date such as will be seen by the end of next week) that the health care professional would be willing to accept an extra appointment. Accordingly, the number of appointments for the date or range can also be chosen on the system. The system allows for secure access to the system by login ID and password or the like. Likewise, the individual will have access to the system, for example, by login ID and password and can search the list of doctors. In one embodiment the individual can search by criteria set up on the system, for example, date range, professional location, specialty, and the like, could if desired, be search criteria.

The system will also handle the information regarding payment or in one embodiment the transaction itself. Where cash or check is utilized, it could be sent to the system host or the physician directly. The system host could take a portion of the fee as payment and/or place advertisements on the server for viewing when the system is accessed. In one embodiment, the system could have or be associated with an online payment system which accepts credit cards, account withdrawals, or the like, such as the current Pay Pal system of online payment. Once the system verifies that the payment has been made the appointment is verified. That could occur online or by the individual directly contacting the professional. Where only a date range is guaranteed, e.g. by next Friday, the professional would confirm with the individual the exact date the appointment would be and the time or time approximation for the individual to arrive for the appointment.

The system can also handle other information, such as the reason for the healthcare visit, the uploading and sharing of healthcare information, such as medical records, X-rays, MRIs, and the like.

As used herein the phrase “time period” refers to either a specific date and time an appointment is available, a time range an appointment is available, an availability of an appointment that will be no later than a specific date, or the like. The specific date and time for the appointment is generated after the time period is selected and the appointment paid for.

The term “registering” refers to the system having a means to identify the person utilizing the system. For example, a login and password or the like could be utilized. Since sensitive healthcare information could potentially be exchanged by the system, other more secure means of individual or healthcare professional recognition could be utilized such as fingerprint readers, face recognition software, iris identification, or the like to insure only the identified individual or professional has access to the medical system.

The present invention “search” function as described above allows the individual to go onto the internet access the system and to select a healthcare professional that meets the criteria necessary for the particular appointment. Therefore, as described above where a physician is needed, the search can be limited to physicians. It could be further limited to sub specialists, location, time and the like. Location could be a city or radius from the individual or the like. Time could be a specific day and time, a range of times, or a by a certain date and time. In other embodiments it could be limited by professional ratings, review criteria (e.g. 1 to 5 stars), or the like.

One of the key parts of the present invention is the prepayment for the appointment. The incentive for the healthcare professional to have additional appointments is the prepay function, thus avoiding the normal insurance costs associated with the appointment. Frequently, in addition to appointment charges, certain other items such as medical testing, blood tests, injections, and the like must also be paid for but these can be paid for in the traditional manner or could be required to be either paid for at the appointment, prepaid or advance credit charge, or credit information given to insure immediate payment.

The final “appointment” can be done by the system on the internet based server or by contact of the individual and professional such as by phone, e-mail, or the like. With the present system, if the individual does not show for the appointment, the payment is lost and non-refundable. This way the physician has yet another incentive to participate with the system of the present invention. Because, as noted above, the cost of third party systems, missed appointments, and the like are so high and the present system allows for guaranteed professional payment prior to the appointment, the professional will have an incentive to have some portion of time available for the system.

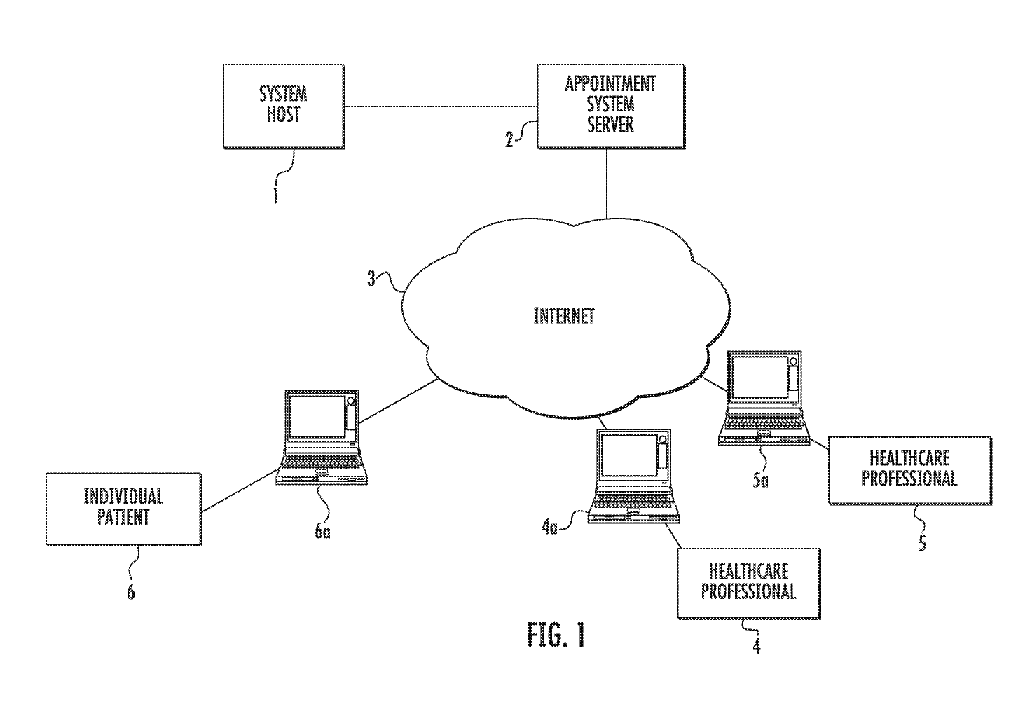

Now referring to the drawings, FIG. 1 is a block diagram of the relationship between the internet and the parties to the system. A system host 1 prepares software and places the software for an appointment system of the present invention in resident or other memory on a server 2 which has access to the internet 3, plurality of healthcare provisionals 4 and 5 each with access to the internet 3 via a computer 4a and 5a access the appointment system and download their available appointment ranges and location, specialties, etc. to the server 2.

The individual patient 6 in searching for an appointment accesses the internet 3 via computer 6a and reaches the appointment system and searches for appointments available in the time period and other criteria available for healthcare professionals 4 and 5.

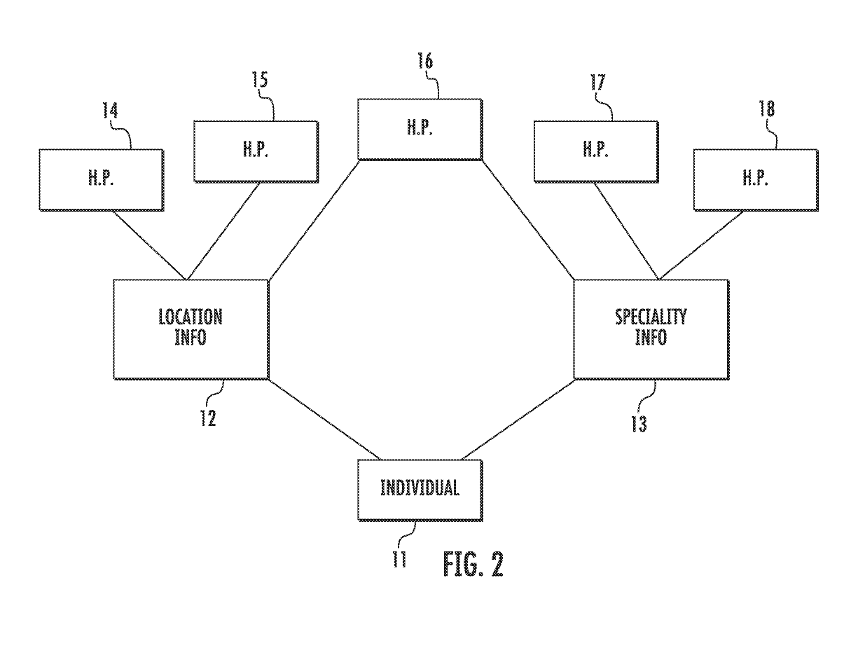

FIG. 2 is a block diagram of the individual 11 searching the appointment system. The individual 11 in this embodiment has a choice of location 12 (e.g. by radius from the individual, zip code, city, or the like) and can find healthcare professionals (HP) 14, 15 and 16. Likewise, the individual 11 can search by specialty 13 and finds HP 16, 17 and 18, thus in this embodiment the individual might choose HP 16 as meeting both criteria. However, the individual 11 can decide on their own desired criteria of those criteria offered in the system as implemented.

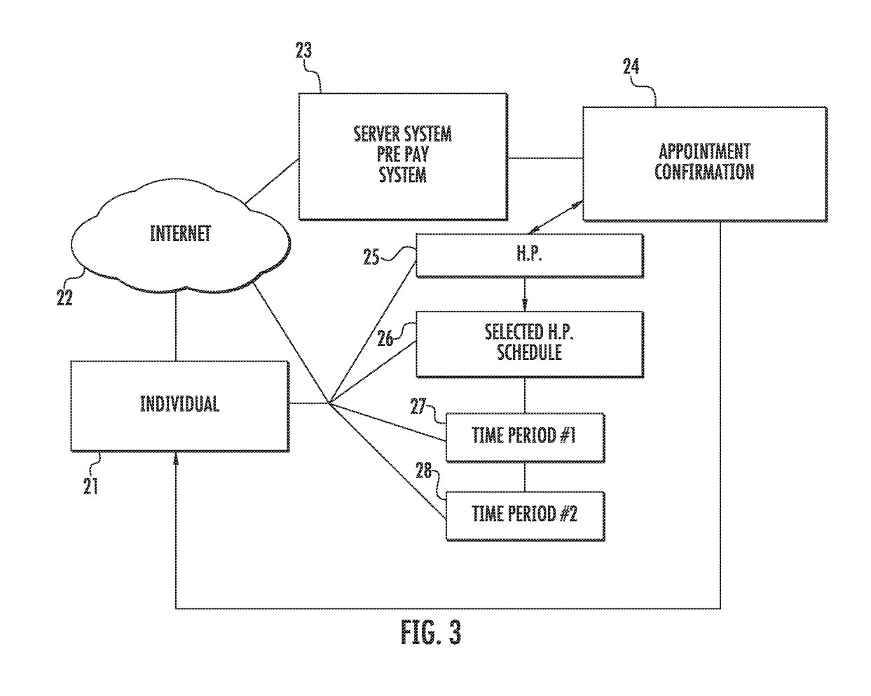

FIG. 3 is a block diagram of the individual selecting the time period and prepaying for the appointment along with the final confirmation of the appointment. The individual 21 in this embodiment has accessed the internet 22 and the appointment system. In this example the individual 21 has already chosen HP 25. The selection of HP 25 also shows the selected HP's available appointment schedule 26 and in this embodiment the schedule 26 has two time periods available, time period one 27 and time period two 28.

Once selected the individual 21 accesses the system's prepay system on the server 23, the appointment can be paid for. Once that is accomplished, the system sends an appointment confirmation to the individual 21 and the HP 25. If further scheduling (e.g. specific date and time within the period) is necessary, that can be down between the HP and individual, on the system or the like.

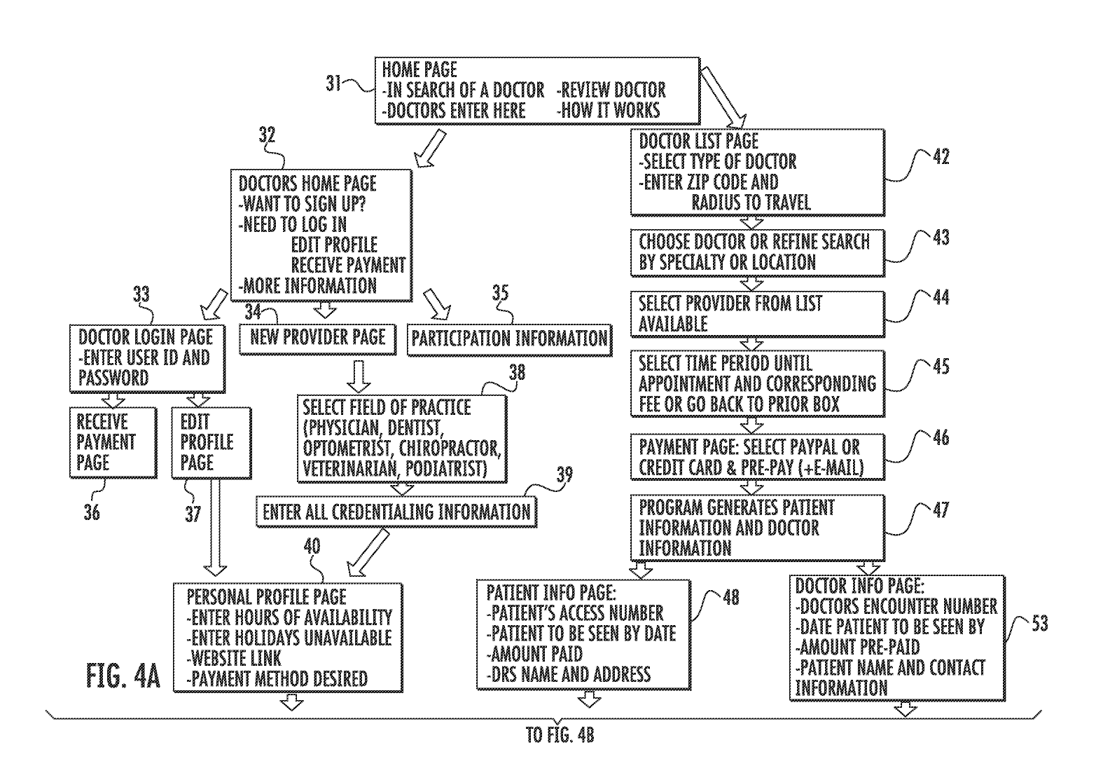

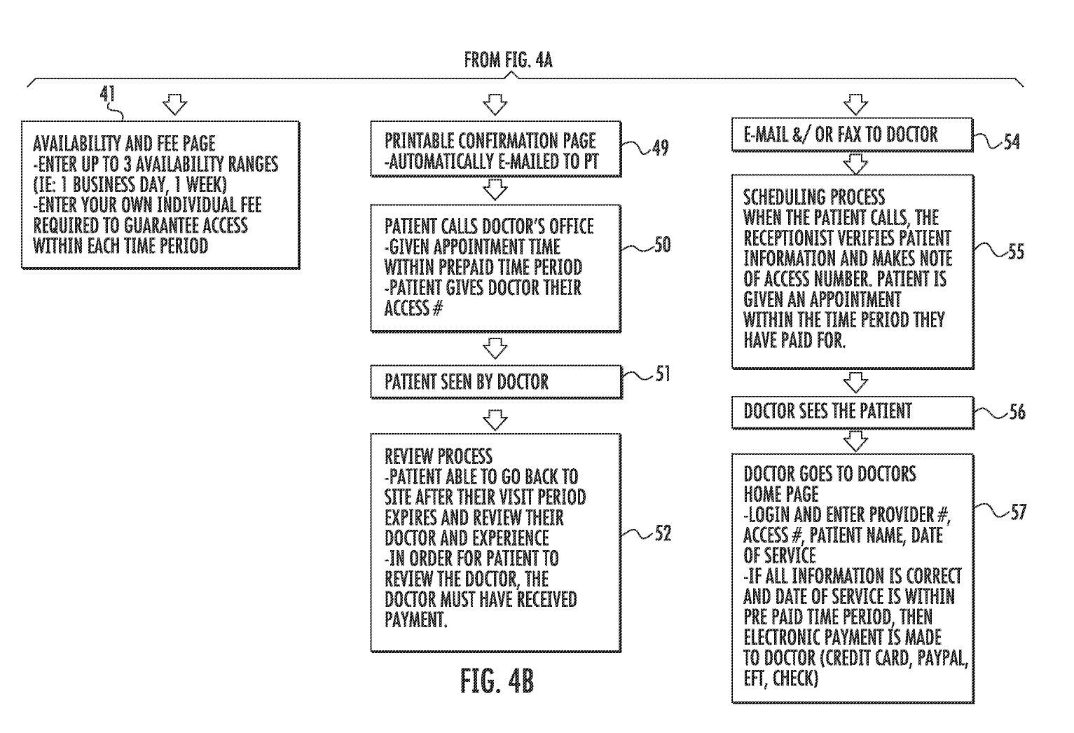

FIGS. 4a and 4b show a more detailed block follow diagram of access to an embodiment of the internet system of the present invention. The figure starts with the GUI page on the internet where either the HP or the individual will access the system. The Home Page 31 is where the individual in search of a doctor starts and the doctor signing up enters first. The Home Page 31 can have access to information on how the system works or HP reviews. In one instance a HP lands on Home Page 31 and goes to the doctor's home page 32. The doctor's home page allows the doctor to sign up, edit, provide and receive payments, and the like. Where the doctor logs in, log in page 33 allows the doctor to enter the ID and password for access to the system. The doctor can then go to a receive payment page 36 to receive payment or other date from an appointment or the like, or edit profile page 37. The edit profile page 37 leads to the profile page 40 which gives general info on hours of availability, holidays, website link, methods of acceptable payment, and the like, while an availability and fee page 41 allows the doctor to edit the time ranges, enter desired fee, and the like.

The doctor can always go from the doctor's page 32 to read participation information 35 or where a new provider to a new provider page 34. The new provider page allows for entry of mostly one time entry information, such as the field of practice 38 and credentialing information 39 which can be utilized to authenticate the participating HP.

The individual starts out with the doctor's list page 42. The list page 42 allows the individual to select the type of HP and either a zip code or radius of travel or the like for the selected doctor. Next, the optional refine search page 43 allows the individual to choose the doctor or refine the search further, e.g. by specialty or specific location. The HP is then selected 44. The individual can then go to a page for selection of available time periods until the appointment and the fee involved 45. Obviously, the other types of appointments or fees and the like could also be positioned here.

Once doctor and time period is selected, the individual is sent or goes to the prepayment page 46 where credit card or the like can be utilized to pay for the appointment. Once paid for, the system generates both patient information and doctor information 47. The individual ends on the patient info page 48. This page can basically be receipt type information including the doctor's contact information and all the limitations of the appointment that has been paid for, such as patient number, to be seen by date and the doctor's name and address. The patient can have a printable confirmation 49 which can also be emailed directly to the patient. In this embodiment the patient gives a phone call to the doctor's office 50 (though this could also be done online) to get the exact appointment time and work out any other details necessary for an appointment with the doctor. The patient is then seen by the doctor at their office on the particular date and time.

In this embodiment, the patient is able to enter a review process 52. The review process 52 allows the patient to go back in the site after their visit and review their doctor experience to review the doctor visit 51 for others to view.

Once the program system has generated the doctor information 47, the doctor is sent information about the appointment via the doctor information page 53. The info page 53 informs the doctor about the patient and the prepaid amount including who the patient is and contact information. Where the info page 53 is not being accessed regularly by the doctor, the system can e-mail or fax 54 the information on the page to the doctor. Where the appointment is for a time period, such as guarantee to see by time period, the scheduling process 55 allows the patient to call the doctor's receptionist to verify the appointment details and the specific appointment time and day they have paid for.

The doctor then sees the patient 56.

After the appointment 56 the doctor goes to the doctor's home page 57. There the doctor can log in and access the patient information and that the appointment occurred, thus triggering the system to pay the doctor by an agreed upon method.

What is claimed is:

1-8. (canceled)

9. A method for an individual patient to schedule an appointment on an internet with a healthcare professional comprising:
a) a system host preparing and placing an appointment system in resident memory on an appointment system server with access to the internet wherein the appointment system via the server over the internet can collect a healthcare professional time period for an available appointment and a cost for an appointment during the time period and present the time period and cost to the patient;
b) the healthcare professional accessing the appointment system on the server via a computer on the internet and downloading the healthcare professional's available time period and cost of an appointment on the appointment scheduling system on the internet accessible server wherein the healthcare professional guarantees an appointment time and date during the time period in exchange for a prepayment of the cost;
c) the server making available to the patient over the internet the time periods an appointment is available by prepayment which can be assigned to the patient;
d) the patient accessing the appointment system on the server via a computer on the internet and registering on the appointment system;
e) the appointment system on the server allowing the registered patient accessing the appointment system to search the system and select the time period;
f) prepayment of the cost by the patient for the selected time period; and
g) the healthcare professional assigning an appointment date and time to the patient that is within the time period once the prepayment is complete.

10. The method according to claim 9 wherein there are a plurality of healthcare professionals which can be selected by the patient that each have an available time period.

11. The method according to claim 10 wherein the healthcare professional may be selected by at least one of specialty and location.

12. The method according to claim 9 wherein the time period is a range of dates and times.

13. The method according to claim 9 wherein the individual is able to review information about the healthcare professional.

14. The method according to claim 13 wherein there are reviews of the healthcare professionals by other individuals making appointments on the system for review by the individual.

15. The method according to claim 9 wherein the server handles the prepayment of the cost over the internet.

16. An internet based appointment scheduling system for an individual patient having access to the internet to obtain an appointment with a healthcare professional having access to the internet comprising:
a) a system host;
b) an internet accessible appointment system server controlled by the system host;
c) an appointment scheduling system placed in resident memory on the internet accessible server and controlled by the system host wherein the appointment scheduling system can perform the operations of:
i. registering an available time period the healthcare professional will make an appointment available in exchange for the prepayment of a cost;
ii. registering the patient;
iii. allowing the registered patient to access the appointment scheduling system over the internet and select the time period of the healthcare professional;
iv. accepting prepayment of the cost;
d) the healthcare professional assigning the available appointment date and time within the time period to the patient once the prepayment of the cost has been accepted.

17. The system according to claim 16 which further comprises a plurality of healthcare providers, each having a time period and cost, and a plurality of patients.

18. The system according to claim 16 wherein the system allows the patient to select the healthcare professional by at least one of field of practice and location of practice.

19. The system according to claim 16 wherein the system has healthcare professional reviews for review by the individual.
